(19) United States
(12) Patent Application Publication
(10) Pub. No.: US 2018/0218633 A1
(43) Pub. Date: Aug. 2, 2018

(54) Fretboard light strips with illuminable note indicia

(71) Applicant: David Christopher Jacobsen, Venice, FL (US)

(72) Inventor: David Christopher Jacobsen, Venice, FL (US)

(21) Appl. No.: 15/932,083

(22) Filed: Feb. 1, 2018

Related U.S. Application Data
(60) Provisional application No. 62/499,479, filed on Jan. 27, 2017.

(51) Int. Cl. G09B 15/00; F21S 4/28; H05B 33/08; G10D 3/06; H05B 37/02

(52) U.S. Cl. CPC G09B 15/003; F21S 4/28; H05B 37/029; G10D 3/06; H05B 33/0842

(57) ABSTRACT

The present invention is a device and method for teaching note locations, fretboard patterns, scales, chords, and songs on the fingerboard of a fretted stringed instrument (“fretboard”), such as an electric or acoustic guitar, bass guitar, or other fretted instrument. The invention comprises a set of affixable fretboard strips (“strips”) that adhere to the surface of the stringed instrument, using a mild adhesive or other means of attachment, so as not to damage the instrument, and a number of electronic illuminable markings, such as LED lights, which indicate musical notes and concepts. Once applied to an instrument, an external controller illuminates the electronic illuminable markings in sequence in order to communicate the note positions of notes, scales, chords, playable patterns and songs in order to teach the same to would be students.

### PROVISIONAL PATENT CROSS-REFERENCE PRIORITY CLAIM

The present invention claims priority date benefit from provisional patent application number 62/499,479.

### FIELD OF THE INVENTION

The present invention relates to the field of teaching aids for stringed instruments.

### BACKGROUND OF THE INVENTION

Most stringed instruments share a number of common features: sound holes, a sound box, a fretboard or fingerboard, a neck, a nut, a head, tuning pegs, a bridge, and of course strings. In the case of fretted stringed instruments, the fingerboard further contains “frets,” which are raised bars that transverse the fingerboard at various intervals parallel to the bottom of the instrument. The challenge of all would-be players is essentially the same: learning to skillfully play various “notes”, “chords”, “phrases”, “scales”, “note sequences”, and “patterns” by manipulating the strings of the instrument of choice in space-time.

To play one “note” on a stringed fretted instrument, one must cause one of its many strings to vibrate at one of its possible frequencies or “pitches”. To select the pitch and corresponding note to be played, the player depresses the string on the fretboard between two frets, causing the length of the string that is vibrating when plucked to effectively change temporarily. When the length of the portion of a given string that is vibrating changes, the frequency of the sound wave emanating also changes which forms the pitch of the note being played. Because each fret is placed at a different length from the bridge pin (the device which holds each string in place), the player can play a variety of notes and corresponding frequencies by depressing the string between different frets before plucking the string.

While learning how to cause strings to vibrate in a manner that is sufficiently pleasing to the ears to pass as “music” may be achieved by a variety of means, a number of common devices are typically employed. Mnemonic devices are often used to teach students the names of sequences of notes and to memorize which notes are needed to form various “chords,” which are combinations of various singular notes played at the same time. And visual cues such as fretboard diagrams are often used to teach students where to place their fingers in order to produce various notes.

Although there are a number of books, videos, and online resources devoted to providing students with visual cues needed to learn the fundamental skills required to learn a stringed instrument, most of these learning aids share a common deficiency: the fretboard patterns, note locations, or chords to be learned are printed on something other than the fretboard of the guitar itself. This forces students to expend a great deal of mental effort in order to figure out how the fretboard patterns, note locations, or chords to be learned, as printed on the visual cue, correspond to the actual instrument being used. The present invention seeks to eliminate this shortcoming by offering students a set of visual cues that can be affixed directly to the surface of the fretboard.

A variety of devices, besides the present invention, have been employed to attempt to affix visual cues directly to the surface of the fretboard. However, all of the devices existing in the prior art have significant shortcomings, making them ineffective, inefficient or otherwise unattractive to use.

Some devices have a one-piece sheet of pliable material, such as linen, muslin, or aluminum, extending along the length of the fretboard, having fret openings cut throughout the material, which can be secured to the sides of the fretboard using pins. This type of visual cue device, while offering a means to place the lessons to be learned right on the fretboard, is cumbersome and potentially damaging to the instrument. Moreover, because the invention is a one-piece sheet of material, the openings cut throughout the material must be fairly large to accommodate the frets, given that the frets are spaced differently on different types of guitars. This limits the size of printing space. More importantly, because the invention is comprised of one continuous piece of material, the student must either cover the entire fretboard at once or else forgo using the learning device entirely. This is problematic because in some instances it is beneficial for students to deprive themselves of visual cues when unnecessary in order to challenge themselves to allow their brain to do the work otherwise done by the visual cue. Therefore, there are a great number of instances in which it is beneficial to allow students to apply visual cues to some frets but not others.

Other devices have a sheet of autogenously adhesive plastic, such as cling vinyl, on which is printed a series of markers indicating note locations, scales, or chords. These devices are cumbersome to apply, require students to cover the entire fretboard or else forgo using the device entirely, and hamper natural contact between the guitar player's thumb and the back of the guitar neck, since they must cover the entire guitar neck in order to adhere to themselves. This later drawback is significant, since guitar players must constantly slide their thumb up and down the guitar neck in order to play various chords and notes. Thus, these devices threaten optimal playing ability while reinforcing in students' mind and muscle memory incorrect assumptions about the friction levels of the back of the guitar neck.

Other devices have a series of cards, which can be alternately placed on the fretboard of the guitar and then withdrawn after the fingers are placed in the proper positions. The lack of permanency of the visual cue requires students to continually stop instrument play to put the relevant card on the fretboard whenever information is needed. This drawback alone is sufficient to make these devices virtually worthless to students trying to learn long musical phrases and complex fretboard patterns.

Another device has been devised to directly affix removable vinyl stickers to the surface of the frets temporarily with note indicia. These removable fret stickers are useful as a temporary solution, however the main drawback of this solution is that the stickers are for one time use and the markings printed on the stickers cannot be changed to communicate new patterns, notes, chords, and scales. Thus an entirely new set of stickers must be applied to teach new patterns, notes, chords, and scales.

A further drawback is that the permanent markings pre-printed on such stickers can not communicate nuanced subtleties such as the order of notes played in time. While they are effective in communicating which notes are permissible in a given scale or pattern, they do not effectively communicate the order, duration, and timing of each note. Thus such devices are ill equipped to teach songs, which are often comprised of hundreds of notes, chords, and patterns played for various durations over the course of many minutes.

Yet another device consists of a guitar with built in tiny light bulbs corresponding to each note, which illuminate to indicate various note positions. While useful, this invention forces users to purchase a whole new guitar in order to make use. This is expensive and inefficient. What is needed is a device that can be retrofitted to any standard sized fretted instrument, allowing users to save money and learn chords, notes, scales, patterns, and songs on any instrument of choice.

While a number of other methods and devices have been developed for indicating fretboard patterns, note locations, and chord locations on the surface of the fretboard of stringed instruments, all methods and devices existing in the prior art have significant drawbacks. These methods and devices either require permanent changes to the instrument, interfere with proper play, do not teach note names, must cover the entire fretboard to be used at all, or else embody some other discouraging shortcoming. Accordingly, what is needed is a visual cue learning device that can be temporarily fixed to the fretboard of the guitar, fret-by-fret, without damaging the guitar surface, capable of communicating note duration and order for a multitude of patterns, scales, chords, and songs. The present invention meets this need.

### BRIEF SUMMARY OF THE PRESENT INVENTION

The present invention is comprised of a set of individually removable, electronic fretboard strips, which may be adapted for use with all fretted stringed instruments, including but not limited to guitars, bass guitars, banjos, ukuleles, and which may be used to teach students to recognize the locations of notes, fretboard patterns, chords, scales, and other important fundamental musical concepts required to learn to play stringed instruments, and which may also be used to teach more complex patterns and sequences of notes in time, such as those required to learn entire songs.

The removable electronic fretboard strips set comprises a set of flat, thin, strips containing a number of LED or electronic lights, which can be affixed to the fretboard of stringed instrument using low-tack or mildly adhesive stickers, or other means, which indicate musical concepts such as the names and locations of various notes when placed between the appropriate frets of the stringed instrument and the strings of the guitar. The LED or electronic lights illuminate individually, in succession, or simultaneously, as required, on cues sent from a related transponder or controller device in order to teach patterns, note positions, and note sequences along with time sensitive subtleties, such as note duration, note order, musical ‘rests’ and other subtleties required to teach complex patterns, such as those comprising entire songs.

Each strip in the strip set may be applied to the surface of the fretboard individually, or in groups or sets, including the entire set and may be removed individually as well. This allows the greatest level of flexibility in designing teaching methods that implement the sticker sets as visual aids.

Each strip in the set may be individually applied by sliding it underneath the strings of the instrument, aligning the LED or electronic lights directly underneath the strings, and firmly affixing the strip to the surface of the instrument, using an affixing mechanism. In a preferred embodiment, the strip is only wide enough to cover the surface of the fretboard and attach to the sides of the neck, allowing the player of the instrument to make natural contact with the instrument at the back of the neck.

Given recent developments in adhesives technology, there are a number of low-tack adhesives that can be applied to the surface of standard stringed instrument substrates and removed without doing any damage to the surface of the instrument. Such adhesives are incorporated into a preferred embodiment of the affixing mechanism of the present invention, to avoid damaging the instrument's substrate. Depending on the type of adhesive used, the strips may also be removed and reapplied when needed, allowing them to be repositioned and, in some cases, reused.

The complete electronic strips set may cover the entire fretboard in one preferred embodiment, but needn't. Each electronic strip within the set is thin enough to allow the strings to make clean contact with the frets of the instrument, so as to not inhibit clean sound production of the instrument. Furthermore, each strip contains illuminable bulbs or devices, such as LED lights or other electronic lights that can illuminate one at a time, whenever signals are sent via a remote electronic controller device. Communication between the controller device and the individual lights on the electronic strips can be made using electric signals via wires or, alternatively, may be made using WiFi signals, according to the well known and established principals of electronics and wireless device communications.

In a preferred embodiment, each light in the set of electronic strips set corresponds to one possible note position on the fretted instrument. Each light can be controlled individually and can be illuminated one at a time, in succession, or simultaneously or in combination with other lights. The duration, sequences, length, and even color of illumination may be controlled by the controller and controller software, to indicate note duration, velocity, and sequence.

In one preferred embodiment, the controller is a smart phone or portable electronic device that communicates with each of the LED or electronic lights on the strips set individually via WiFi signal. In another preferred embodiment, the controller is a stand-alone device.

In one preferred embodiment, the controller has software that can be easily updated from time to time to include new patterns, songs, or note sequences that can be learned/taught. In one preferred embodiment, new patterns, songs, or note sequences can be downloaded from the Internet during software updates.

In one preferred embodiment, the tempo of the pattern, song, or note sequence to be learned can be controlled by the controller, allowing the student to slow down the duration of each note in the pattern, song, or note sequence to be learned, to aid in learning.

In one preferred embodiment, the controller can play audible notes through a speaker corresponding to the pitch of each note signaled via LED or electronic light in order to provide auditory cues to coincide with the visual cues being provided via the LED or electronic lights.

The controller and electronic strips set may be used in conjunction with sheet music, or other external visual cues, and auditory cues, to assist in teaching the patterns, songs, or notes sequences to be learned, where useful and/or helpful.

The primary object of the present invention is to create useful visual devices to aid students in learning the location of various important musical concepts and features on the fretboard of stringed instruments, corresponding to vast collections of musical patterns, songs, and note sequences.

A further object of the present invention is to provide a learning device for teaching students of stringed instruments that indicates the location and temporal sequence of individual notes to be played in a way that Is easily ascertained.

A further object of the present invention is to provide a learning device for teaching students of stringed instruments that indicates the location and temporal sequence of individual notes which can be easily applied to and removed from the surface of the chosen instrument.

A further object of the present invention is to provide a learning device for teaching students of stringed instruments that indicates the location and temporal sequence of individual notes which can be be adapted to a wide variety of teaching methods, including those requiring fret-by-fret visual cues.

A further object of the present invention is to provide a learning device for teaching students of stringed instruments that indicates the location and temporal sequence of individual notes which does not interfere with the natural feel and play of the instrument.

A further object of the present invention is to provide a learning device for teaching students of stringed instruments that indicates the location and temporal sequence of individual notes which does not prevent normal contact with the back of the neck of the stringed instrument.

A further object of the present invention is to provide a learning device or system of devices for teaching students of stringed instruments that can be flexibly accommodated to a variety of standard sized instruments.

A further object of the present invention is to provide a learning device for teaching students of stringed instruments capable of indicating the location and temporal sequence of individual notes to a vast collection and wide variety of patterns, songs, and sequences.

A further object of the present invention is to provide a learning device for teaching students of stringed instruments, which can be retrofitted to and removed from an existing instrument.

A further object of the present invention is to provide a learning device for teaching students of stringed instruments that leverages the prevalence and advanced capabilities of existing smart phone technology as a controller device.

Other objects, advantages, and novel features of the present invention are set forth in part in the detailed description to follow, taken in conjunction with the accompanying drawings. Further objects, advantages, and novel features may be learned by practice of the invention. The objects and advantages of the present invention may also be realized and attained by means of the appended claims.

### BRIEF DESCRIPTION OF THE DRAWINGS

Having thus described the invention in general terms, reference will now be made to the accompanying drawings, which are not necessarily drawn to scale, and wherein:

FIG. 1 provides a frontal view of one embodiment of the present invention, including the controller sending a signal to one note on a set of four electronic LED strips.

### DETAILED DESCRIPTION OF THE INVENTION

The present invention consists of a set of removable electronic LED or light strips 1, which can be affixed to the surface of a fretted instrument using a variety of attachment mechanisms 2, including but not limited to adhesives technologies having illuminable LED or electronic lights 3, 4 that provide visual cues for players of stringed fretted instruments attempting to learn patterns, note sequences, scales, chords, note positions, or songs. Each LED or light strip 1 is made of a thin, flexible material, such as plastic or vinyl, or similarly flexible and, ideally, durable materials and attaches directly to the fretboard of a fretted stringed instrument of choice and may be removed without damaging the instrument's substrates or finish.

The lights of the LED or light strips 3, 4 are illuminated by a controller device 5, via an electric or radio wave signal or wired or wirelessly transmitted signal 6, sent by a controller 5, and may be illuminated one at a time 4 or simultaneously, or in sequence, for various durations and in various colors, as determined by software or circuit boards of the controller 5 in conjunction with the materials constituting the light strips.

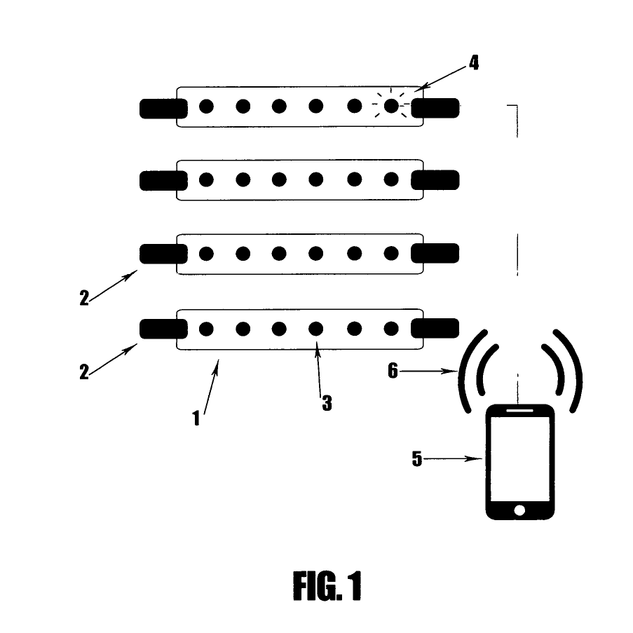

FIG. 1 shows a frontal view of a preferred embodiment of the present invention that is applicable to a standard sized acoustic or electric guitar. In this preferred embodiment, the set of removable electronic LED strips comprises four removable strips 1 having a rectangular or trapezoidal planer top surface and a rectangular or trapezoidal planar bottom surface. Although this preferred embodiment contains only four removable strips 1, each corresponding to the first four frets of the guitar, a set of strips may include twelve or twenty-four or more or less strips and may cover the entire length of the fretboard, if desired.

In a preferred embodiment, each light strip 1 is made of a thin, flexible, but strong, non-stretching material, such as vinyl or plastic, or similar material. In a preferred embodiment, each strip 1 is bendable, but not easily stretched or broken. Each light strip 1 corresponds to one fret of the fretboard and in a preferred embodiment contains as many lights 3 as there are strings for the given instrument. In at least one preferred embodiment, the strips 1 are for use on a six stringed instrument, in which case there will be, in at least one preferred embodiment, six lights 3 per light strip, one corresponding to each possible note that can be played on the strips corresponding to any given fret.

Each light strip 1 can be easily slipped under the strings of an existing standard sized instrument then attached using an affixing mechanism 2. The affixing mechanism 2 may be made of 3.5 mil, clear gloss flexible vinyl that includes adhesives, or Velcro, or may be made of other materials. The affixing mechanism 2 may be permanently attached to the strips or may be temporarily attached and may be replaceable. If a clear gloss flexible vinyl is used as the affixing mechanism, the bottom surface of the vinyl may be coated with an ultra low-tack removable adhesive, such as 64 ultra low-tack removable acrylic, so as to not damage the wood substrate. Preferably the target adhesive used allow the affixing mechanism to be cleanly removed from most wood lacquered finishes for up to 6 months or longer.

The preferred overall dimensions of each light strip 1 will vary, depending on the instrument to which each strip set pertains, however, a number of important limitations of said dimensions may be noted. The width of the strips to be placed between the frets closest to the head of the stringed instrument may be smaller than the width of the strips to be placed between the frets furthest from the head of the stringed instrument to account for the trapezoidal aspect of fretboards. Also, the height of each strip may be smaller than the distance between the frets to be covered by the strip at issue. Finally, the width of each strip may be limited to no more than is necessary to cover the entire width of the fretboard of the instrument where the strip is to be attached, plus a small amount of space to grip the sides of the neck of the instrument. This limitation allows the player of the instrument to make natural contact to the surface of the back of the neck of the instrument with one's thumb even when the strips are attached to the fretboard of the instrument.

The top surface of each light strip 1 does not contain adhesive. It does contain, however, illuminable mechanisms 3, 4, such as LED lights or other electronic lights, which can be controlled via an external wireless or wired controller device 5.

The controller 5 may be comprised of a portable hand held device, such as a smart phone or tablet, or it may be comprised of a computer, or a standalone controller made specifically for the purposes of controlling the led light strips set.

The controller contains software in a preferred embodiment, which can be updated from time to time. This software communicates with each light 3 of the light strips individually via the controller and is capable of lighting one note light 4 at a time or multiple notes simultaneously or in sequence.

In one preferred embodiment, a smart phone is used as the controller 5. In this preferred embodiment, the smart phone 5 communicates with each light 3 in the light strip 1 individually via wireless signals 6 in order to indicate when and for how long to illuminate any given light, which in turn, indicates to the fretted instrument student when and for how long a given note should be played.

In this preferred embodiment, the light strips 1 may be attached to the fretted instrument using vinyl strips 2 containing a mild adhesive on the bottom surface, which can be replaced and removed from the instrument, when appropriate. The lights 3, 4 of each light strip 1 are not illuminated during rests 3, and are illuminated 4 when the corresponding note to a given light ought to be played.

In a preferred embodiment, the color of the lights 3, 4 contained in the light strips may also be controlled via the controller 5, and may change to indicate note velocity or according to user preference, or for other reasons.

These figures, along with the accompanying descriptions demonstrate a unique, novel, and superior solution to the problem of providing visual cues for learning to play stringed instruments on the surface of the instrument itself. The present invention's ease of application, universal applicability, aesthetic appeal, streamline and simple design, and incremental application process cause it to be superior to all similar inventions, providing a substantial and significant improvement to all prior art.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

The embodiments of the invention in which an exclusive property or privilege is claimed are:

1. a device comprising:
a set of affixable light strips for a stringed instrument, wherein each light contained on each light strip corresponds to a permissible musical note position, which may illuminate in a variety of sequences and rhythms according to cues sent from a controller device to communicate musical concepts, scales, melodies, chords, patterns, and songs, further wherein each strip temporarily affixes to and can be removed from a stringed instrument using an attachment mechanism or adhesive element.

2. a method of affixing illuminable visual sequential or non-sequential cues for indicating musical concepts, scales, melodies, chords, patterns, and songs to a surface of a fretboard of a stringed instrument, comprising:
illuminable musical indicia indicating musical note positions or musical concepts, scales, melodies, chords, patterns, and songs on a set of affixable light strips; and
affixing the set of strips to the surface of the fretboard of a string instrument;
wherein each sticker within the set is placed between frets and underneath strings of the stringed instrument.
